(19) United States
(12) Patent Application Publication
(10) Pub. No.: US 2013/0291548 A1
(43) Pub. Date: Nov. 7, 2013

(54) COMBUSTOR MIXING JOINT AND METHODS OF IMPROVING DURABILITY OF A FIRST STAGE BUCKET OF A TURBINE

(71) Applicant: General Electric Company, Schenectady, NY (US)

(72) Inventors: Clint L. Ingram, Simpsonville, SC (US); Gunnar Leif Siden, Greenville, SC (US)

(21) Appl. No.: 13/932,161

(22) Filed: Jul. 1, 2013

Related U.S. Application Data
(63) Continuation-in-part of application No. 13/036,084, filed on Feb. 28, 2011.

(51) Int. Cl. F02C 9/16

(52) U.S. Cl. CPC F02C 9/16
USPC 60/772; 60/39.37

(57) ABSTRACT

The present application and the resultant patent provide a method of improving durability of a first stage bucket of a turbine of a gas turbine engine. The method may include the steps of generating a first combustion flow in a first can combustor and a second combustion flow in a second can combustor, wherein the first can combustor and the second can combustor meet at a joint comprising a flow disruption surface; passing the first combustion flow and the second combustion flow over the flow disruption surface and to a mixing region; substantially mixing the first combustion flow and the second combustion flow in the mixing region to form a mixed combustion flow; and passing the mixed combustion flow to a first stage bucket of a turbine.

### CROSS REFERENCE TO RELATED APPLICATIONS

This application is a continuation-in-part of copending U.S. patent application Ser. No. 13/036,084, filed on Feb. 28, 2011, which is hereby incorporated by reference in its entirety.

### TECHNICAL FIELD

The present application relates generally to gas turbine engines and more particularly relates to a joint between adjacent can combustors to promote mixing of the respective combustion streams downstream thereof before entry into a first stage of a turbine, and to related methods of improving durability of a first stage bucket.

### BACKGROUND OF THE INVENTION

Can-annular combustors often are used with gas turbine engines. Generally described, a can-annular combustor may have a number of individual can combustors that are circumferentially spaced in an annular arrangement between a compressor and a turbine. Each can combustor separately generates combustion gases that are directed downstream towards the first stage of the turbine.

The mixing of these separate combustion streams is largely a function of the free stream Mach number at which the mixing is taking place as well as the differences in momentum and energy between the combustion streams. Moreover, a stagnant flow region or wake in a low flow velocity region may exist downstream of a joint between adjacent can combustors due to the bluntness of the joint. As such, the non-uniform combustor flows may have a Mach number of only about 0.1 when leaving the can combustors. Practically speaking, the axial distance between the exit of the can combustors and the leading edge of a first stage nozzle is relatively small such that little mixing actually may take place before entry into the turbine.

The combustor flows then may be strongly accelerated in the first stage nozzle to a Mach number of about 1.0. This acceleration may exaggerate the non-uniformities in the flow fields and hence create high mixing losses downstream thereof. As the now strongly nonuniform flow field enters the first stage bucket, the majority of mixing losses may take place therein as the wakes from the can combustor joints may be mixed by an unsteady flow process. Due to the nonuniform flow and unsteady mixing, the first stage bucket may be subjected to high cycle fatigue loads and thermal loads that significantly reduce durability of the first stage bucket.

There is thus a desire for an improved combustor design that may minimize mixing loses. Such reduced mixing loses may reduce overall pressure losses without increasing the axial distance between the combustor and the turbine, which may improve overall system performance and efficiency. Such an improved combustor design also may reduce high cycle fatigue loads and thermal loads on the first stage bucket, which may improve durability of the first stage bucket.

### SUMMARY OF THE INVENTION

The present application and the resultant patent thus provide a method of improving durability of a first stage bucket of a turbine of a gas turbine engine. The method may include the steps of generating a first combustion flow in a first can combustor and a second combustion flow in a second can combustor, wherein the first can combustor and the second can combustor meet at a joint including a flow disruption surface; passing the first combustion flow and the second combustion flow over the flow disruption surface and to a mixing region; substantially mixing the first combustion flow and the second combustion flow in the mixing region to form a mixed combustion flow; and passing the mixed combustion flow to a first stage bucket of a turbine.

The present application and the resultant patent further provide a gas turbine engine. The gas turbine engine may include a first can combustor generating a first combustion flow; a second can combustor generating a second combustion flow, wherein the first can combustor and the second can combustor meet at a joint including a flow disruption surface; and a turbine comprising a first stage bucket; wherein the flow disruption surface promotes mixing of the first combustion flow and the second combustion flow to form a mixed combustion flow in a mixing region upstream of the first stage bucket to improve durability of the first stage bucket.

The present application and the resultant patent further provide a method of improving durability of a first stage bucket of a turbine of a gas turbine engine. The method may include the steps of generating a number of combustion flows in a number of can combustors positioned in a circumferential array, wherein each pair of adjacent can combustors meets at a joint including a flow disruption surface; passing the number of combustion flows over the flow disruption surfaces and to a mixing region; substantially mixing the number of combustion flows in the mixing region to form a mixed combustion flow; and passing the mixed combustion flow to a first stage bucket of a turbine.

These and other features and improvements of the present application will become apparent to one of ordinary skill in the art upon review of the following detailed description when taken in conjunction with the several drawings and the appended claims.

### BRIEF DESCRIPTION OF THE DRAWINGS

FIG. 1 is a schematic view of a known gas turbine engine that may be used herein.

FIG. 2 is a side cross-sectional view of a can combustor that may be used with the gas turbine engine of FIG. 1.

FIG. 3 is an end plan view of a number of adjacent can combustors.

FIG. 4 is a schematic view of a number of adjacent can combustors and the first two rows of turbine airfoils with a wake downstream of the can combustors.

FIG. 5 is a schematic view of a number of adjacent can combustors and the first two rows of turbine airfoils illustrating the use of the can combustor mixing joints as may be described herein.

FIG. 6 is a perspective view of a can combustor mixing joint as may be described herein.

FIG. 7 is an end plan view of an alternative embodiment of a can combustor mixing joint as may be described herein.

FIG. 8 is an end plan view of an alternative embodiment of a can combustor mixing joint as may be described herein.

### DETAILED DESCRIPTION

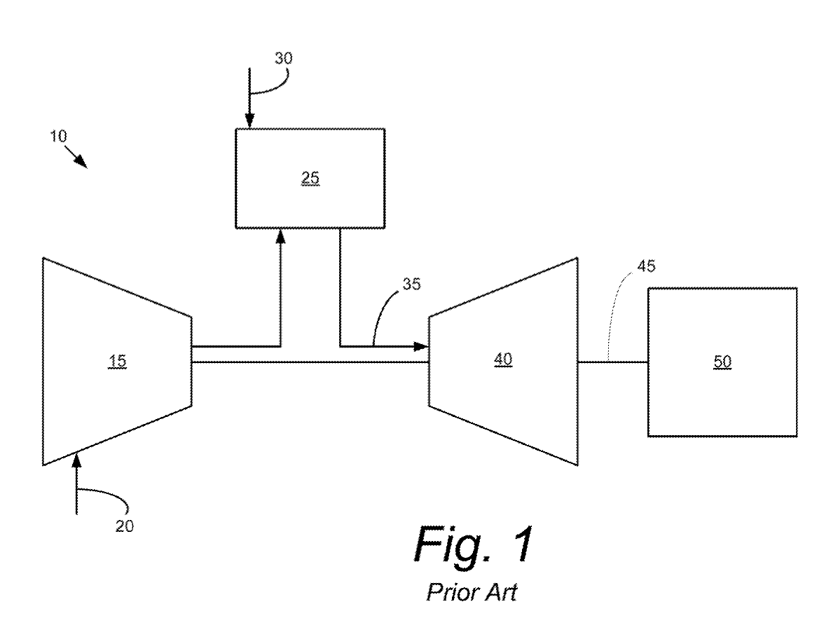

Referring now to the drawings, in which like numerals refer to like elements throughout the several views, FIG. 1 shows a schematic view of gas turbine engine 10 as may be used herein. The gas turbine engine 10 may include a compressor 15. The compressor 15 compresses an incoming flow of air 20. The compressor delivers the compressed flow of air 20 to a combustor 25. The combustor 25 mixes the compressed flow of air 20 with a compressed flow of fuel 30 and ignites the mixture to create a flow of combustion gases 35. Although only a single combustor 25 is shown, the gas turbine engine 10 may include any number of combustors 25. In this example, the combustor 25 may be in the form of a number of can combustors as will be described in more detail below. The flow of combustion gases 35 is in turn delivered to a downstream turbine 40. The flow of combustion gases 35 drives the turbine 40 so as to produce mechanical work. The mechanical work produced in the turbine 40 drives the compressor 15 via a shaft 45 and an external load 50 such as an electrical generator and the like.

The gas turbine engine 10 may use natural gas, various types of syngas, and/or other types of fuels. The gas turbine engine 10 may be any one of a number of different gas turbine engines such as those offered by General Electric Company of Schenectady, New York and the like. The gas turbine engine 10 may have different configurations and may use other types of components. Other types of gas turbine engines also may be used herein. Multiple gas turbine engines, other types of turbines, and other types of power generation equipment also may be used herein together.

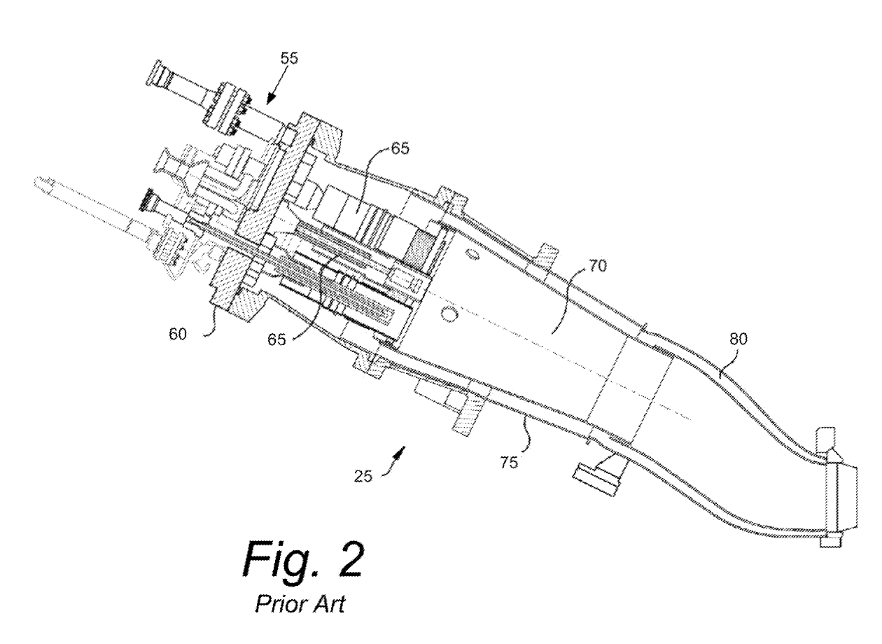

FIG. 2 shows one example of the can combustor 25. Generally described, the can combustor 25 may include a head end 55. The head end 55 generally includes the various manifolds that supply the necessary flows of air 20 and fuel 30. The can combustor 25 also includes an end cover 60. A number of fuel nozzles 65 may be positioned within the end cover 60. A combustion zone 70 may extend downstream of the fuel nozzles 65. The combustion zone 70 may be enclosed within a liner 75. A transition piece 80 may extend downstream of the combustion zone 70. The can combustor 25 described herein is for the purpose of example only. Many other types of combustor designs may be used herein. Other components and other configurations also may be used herein.

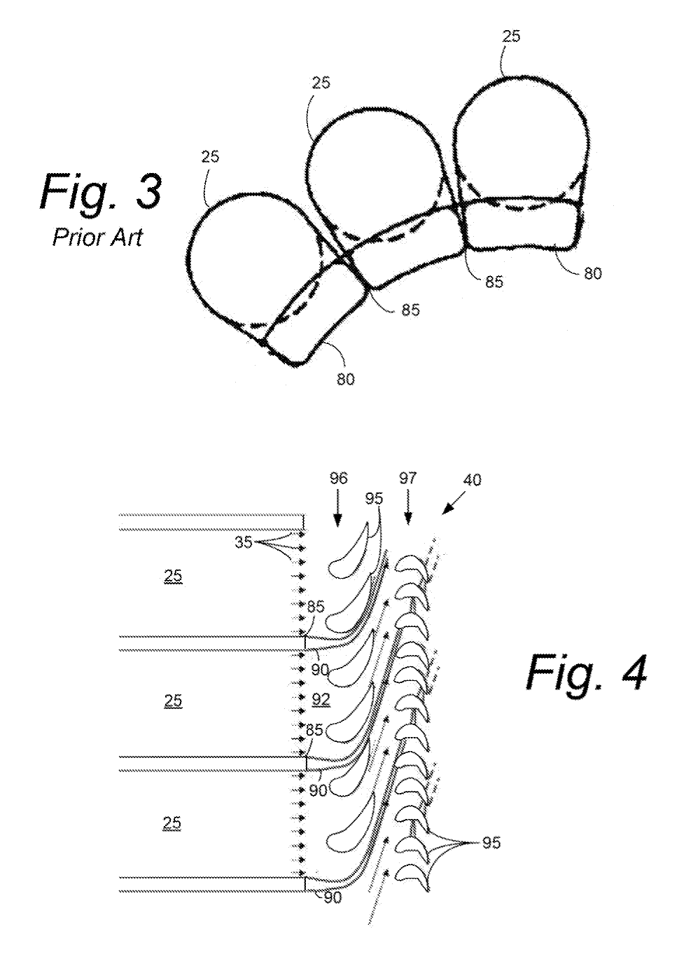

As is shown in FIG. 3, a number of the can combustors 25 may be positioned adjacent one another in a circumferential array. Likewise, as is shown in FIG. 4, each pair of adjacent can combustors 25 may meet at a joint 85. As was described above, the flows of combustion gases 35 through the pair of adjacent can combustors 25 may create a wake 90 downstream of the joint 85. Specifically, the flows of combustion gases 35 may create the wake 90 immediately downstream of the joint 85, as is shown. The wake 90 may be a stagnant flow in a low velocity flow region 92. The wakes 90 of the flows of combustion gases 35 through the number of can combustors 25 extend into the airfoils 95 of the turbine 40. Specifically, the wakes 90 extend into the airfoils 95 of a first stage nozzle 96, wherein the flows of combustion gases 35 are accelerated so as to exaggerate the non-uniformities therein. The flows of combustion gases 35 then exit the first stage nozzle 96 and enter a first stage bucket 97. The wakes 90 of the flows of combustion gases 35 generally mix in the first stage bucket 97 but incur significant mixing and pressure losses. Other components and other configurations may be used herein.

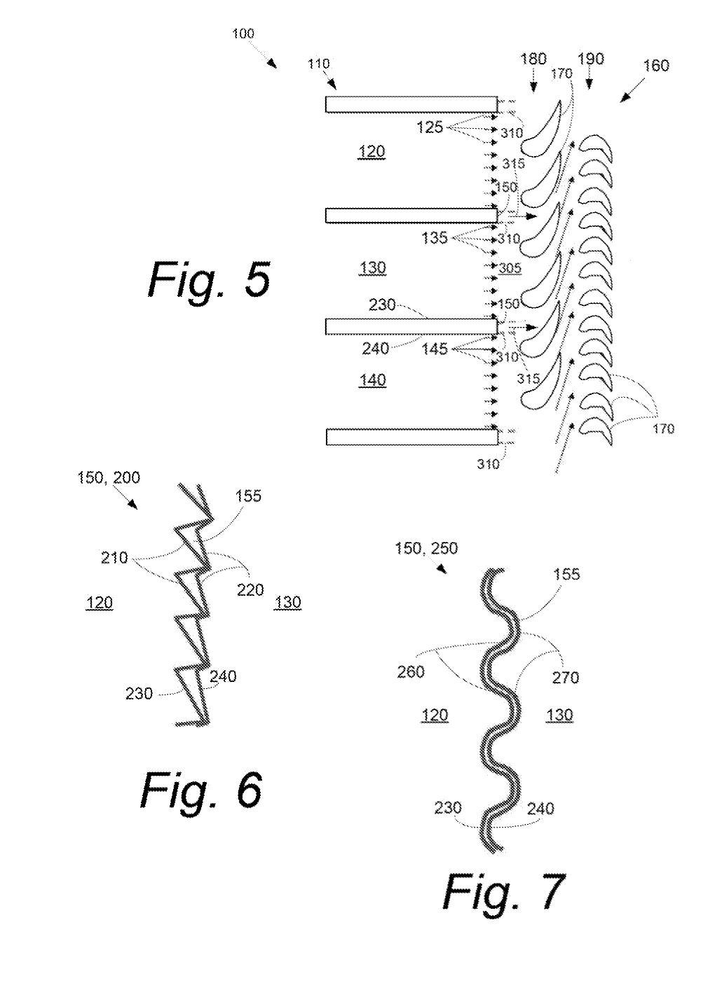

FIG. 5 shows as portion of a gas turbine engine 100 as may be described herein. The gas turbine engine 100 includes a number of adjacent can combustors 110 positioned in a circumferential array. In this example, three (3) can combustors 110 are shown: a first can combustor 120 with a first combustion flow 125, a second can combustor 130 with a second combustion flow 135, and a third can combustor 140 with a third combustion flow 145. Any number of adjacent can combustors 110 may be used herein. Each pair of adjacent can combustors 110 meets at a mixing joint 150. Each mixing joint 150 may have a flow disruption surface 155 defined thereon so as to promote mixing of the combustion flows 125, 135, 145. The gas turbine engine 100 further includes a turbine 160 positioned downstream of the can combustors 110. The turbine 160 includes a number of airfoils 170. In this example, the airfoils 170 may be arranged as a first stage nozzle 180 and a first stage bucket 190 of the turbine 160. Any number of nozzles and buckets may be used herein. Other components and other configurations may be used herein.

FIGS. 6-8 show a number of different embodiments of the mixing joint 150 between adjacent can combustors 110 as may be described herein. FIG. 6 shows a chevron mixing joint 200. The chevron mixing joint 200 may include a first set of chevron like spikes 210 defined by the first can combustor 120 and a corresponding second set of chevron like spikes 220 defined by the second can combustor 130, which define the flow disruption surfaces 155. Specifically, the first set of chevron like spikes 210 may be defined by a downstream edge of a first wall 230 of the first can combustor 120, and the second set of chevron like spikes 220 may be defined by a downstream edge of a second wall 240 of the second can combustor 130. In this manner, the first and second can combustors 120, 130 meet at the chevron mixing joint 200 between the first wall 230 and the second wall 240. As is shown, the flow disruption surfaces 155 may face downstream from the first and second can combustors 120, 130 and toward the turbine 160. Further, as is shown, the depth and angle of the first and second sets of chevron like spikes 210, 220 may vary from the first can combustor 120 to the second can combustor 130. Likewise, the number, size, shape, and configuration of the chevron like spikes 210, 220 each may vary. Other components and other configurations may be used herein.

FIG. 7 shows a further embodiment of the mixing joint 150 as may be described herein. In this embodiment, a lobed mixing joint 250 is shown. The lobed mixing joint 250 may include a first set of lobes 260 defined by the first can combustor 120 and a second set 270 of lobes defined by the second can combustor 130, which define the flow disruption surfaces 155. Specifically, the first set of lobes 260 may be defined by the downstream edge of the first wall 230 of the first can combustor 120, and the second set of lobes 270 may be defined by the downstream edge of the second wall 240 of the second can combustor 130. In this manner, the first and second can combustors 120, 130 meet at the lobed mixing joint 250 between the first wall 230 and the second wall 240. As is shown, the flow disruption surfaces 155 may face downstream from the first and second can combustors 120, 130 and toward the turbine 160. The first and second sets of lobes 260, 270 may have a largely sinusoidal wave like shape and may mate therewith. The depth and shape of the first and second set of lobes 260, 270 also may vary. The number, size, shape, and configuration of the lobes 260, 270 may vary. Other components and configurations may be used herein.

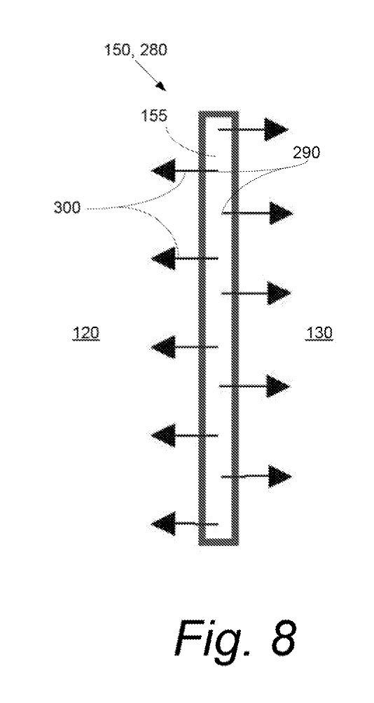

FIG. 8 shows a further embodiment of the mixing joint 150 as may be described herein. In this embodiment, the mixing joint 150 may be in the form of a fluidics mixing joint 280, as is shown. The fluidics mixing joint 280 may include a number of jets 290 therein that act as a flow disruption surface 155. Specifically, as is shown, the jets may be positioned between the first wall 230 of the first can combustor 120 and the second wall 240 of the second can combustor 130. The jets 290 may spray a fluid 300 into the flows of combustion gases 125, 135 as they exit the first can combustor 120 and the second can combustor 130. The number, size, shape, and configuration of the jets 290 may vary. Likewise, the nature of the fluid 300 may vary. Other components and configurations may be used herein.

Referring again to FIG. 5, the use of the mixing joints 150 described herein may enhance the mixing of the combustion flows 125, 135, 145 from adjacent can combustors 120, 130, 140. Specifically, the various geometries of the flow disruption surfaces 155 of the mixing joints 150 may enhance the mixing of the combustion flows 125, 135, 145 in a mixing region 305 positioned downstream of the mixing joints 150. As is shown, the mixing region 305 may be positioned immediately downstream of the mixing joints 150. As a result of the enhanced mixing, a wake 310 formed by the combustion flows 125, 135, 145 may be much smaller than the wake 90 described above. Because the enhanced mixing of the combustion flows 125, 135, 145 occurs in the mixing region 305 before entry into the first stage nozzle 180, the mixing may result in significantly less mixing losses as compared to mixing downstream in the first stage nozzle 180, the first stage bucket 190, or elsewhere. The enhanced mixing thus may reduce the overall pressure losses in the gas turbine engine 100 as a whole without increasing the axial distance between the can combustors 110 and the turbine 160.

Use of the gas turbine engine 100 described herein may include generating the combustion flows 125, 135, 145 in the adjacent can combustors 120, 130, 140 and then passing the combustion flows 125, 135, 145 over the flow disruption surfaces 155 of the mixing joints 150 and to the mixing region 305. The combustion flows 125, 135, 145 may be passed over the flow disruption surfaces 155 and to the mixing region 305 at a first velocity. In this manner, the combustion flows 125, 135, 145 from the adjacent can combustors 120, 130, 140 may substantially mix in the mixing region 305 to form a mixed combustion flow 315 upstream of and before entry into the turbine 160. In other words, the mixed combustion flow 315 may be a substantially homogenous mixture of the combustion flows 125, 135, 145 from the adjacent can combustors 120, 130, 140. The mixed combustion flow 315 then may be passed to the first stage nozzle 180 of the turbine 160, in which the mixed combustion flow 315 may be accelerated to a second velocity greater than the first velocity. The mixed combustion flow 315 then may be passed to the first stage bucket 190 of the turbine 160 at the second velocity. Because the mixed combustion flow 315 is formed upstream of and before entry into the turbine 160, the passing of the mixed combustion flow 315 to the first stage bucket 190 may generate a substantially uniform velocity field in the first stage bucket 190. Moreover, because the mixed combustion flow 315 is formed upstream of and before entry into the turbine 160, the passing of the mixed combustion flow 315 to the first stage bucket 190 may generate a substantially uniform temperature field in the first stage bucket 190. In this manner, the first stage turbine bucket 190 may be subjected to reduced high cycle fatigue loads as well as reduced thermal loads. The mixed combustion flow 315 formed during use of the gas turbine engine 100 thus may improve the durability of the first stage bucket 190.

The embodiments of the mixing joint 150 described herein are for purposes of example only. Other mixing joint geometries or other types of flow disruption surfaces 155 that enhance mixing of the combustion flows 125, 135, 145 from adjacent can combustors 120, 130, 140 before entry into the turbine 160 may be used herein. Different types of flow disruption surfaces 155 may be used herein together. Other components and other configurations also may be used herein.

It should be apparent that the foregoing relates only to certain embodiments of the present application and that numerous changes and modifications may be made herein by one of ordinary skill in the art without departing from the general spirit and scope of the invention as defined by the following claims and the equivalents thereof

We claim:

1. A method of improving durability of a first stage bucket of a turbine of a gas turbine engine, the method comprising:
generating a first combustion flow in a first can combustor and a second combustion flow in a second can combustor, wherein the first can combustor and the second can combustor meet at a joint comprising a flow disruption surface;
passing the first combustion flow and the second combustion flow over the flow disruption surface and to a mixing region;
substantially mixing the first combustion flow and the second combustion flow in the mixing region to form a mixed combustion flow; and
passing the mixed combustion flow to a first stage bucket of a turbine.

2. The method of claim 1, wherein passing the mixed combustion flow to the first stage bucket comprises generating a substantially uniform velocity field in the first stage bucket.

3. The method of claim 1, wherein passing the mixed combustion flow to the first stage bucket comprises generating a substantially uniform temperature field in the first stage bucket.

4. The method of claim 1, wherein the first combustion flow and the second combustion flow are passed to the mixing region at a first velocity, wherein the mixed combustion flow is passed to the first stage bucket at a second velocity, and wherein the second velocity is greater than the first velocity.

5. The method of claim 1, further comprising, prior to passing the mixed combustion flow to the first stage bucket, passing the mixed combustion flow to a first stage nozzle.

6. The method of claim 1, wherein the mixing region is positioned immediately downstream of the joint.

7. The method of claim 1, wherein the flow disruption surface is positioned between a first wall of the first can combustor and a second wall of the second can combustor.

8. The method of claim 7, wherein the flow disruption surface comprises a first set of spikes defined by a downstream edge of the first wall and a second set of spikes defined by a downstream edge of the second wall.

9. The method of claim 8, wherein the first set of spikes and the second set of spikes comprise a chevron like shape.

10. The method of claim 7, wherein the flow disruption surface comprises a first set of lobes defined by a downstream edge of the first wall and a second set of lobes defined by a downstream edge of the second wall.

11. The method of claim 10, wherein the first set of lobes and the second set of lobes comprise a sinusoidal like shape.

12. The method of claim 7, wherein the flow disruption surface comprises a plurality of jets positioned between the first wall and the second wall.

13. The method of claim 12, further comprising spraying a fluid from the plurality of jets into the mixing region.

14. A gas turbine engine, comprising:
a first can combustor generating a first combustion flow;
a second can combustor generating a second combustion flow, wherein the first can combustor and the second can combustor meet at a joint comprising a flow disruption surface; and
a turbine comprising a first stage bucket;
wherein the flow disruption surface promotes mixing of the first combustion flow and the second combustion flow to form a mixed combustion flow in a mixing region upstream of the first stage bucket to improve durability of the first stage bucket.

15. A method of improving durability of a first stage bucket of a turbine of a gas turbine engine, the method comprising:
generating a plurality of combustion flows in a plurality of can combustors positioned in a circumferential array, wherein each pair of adjacent can combustors meets at a joint comprising a flow disruption surface;
passing the plurality of combustion flows over the flow disruption surfaces and to a mixing region;
substantially mixing the plurality of combustion flows in the mixing region to form a mixed combustion flow; and
passing the mixed combustion flow to a first stage bucket of a turbine.

16. The method of claim 15, wherein passing the mixed combustion flow to the first stage bucket comprises generating a substantially uniform velocity field in the first stage bucket.

17. The method of claim 15, wherein passing the mixed combustion flow to the first stage bucket comprises generating a substantially uniform temperature field in the first stage bucket.

18. The method of claim 15, wherein the plurality of combustion flows are passed to the mixing region at a first velocity, wherein the mixed combustion flow is passed to the first stage bucket at a second velocity, and wherein the second velocity is greater than the first velocity.

19. The method of claim 15, further comprising, prior to passing the mixed combustion flow to the first stage bucket, passing the mixed combustion flow to a first stage nozzle.

20. The method of claim 15, wherein the mixing region is positioned immediately downstream of the joints.
